(19) United States
(12) Patent Application Publication
(10) Pub. No.: US 2025/0097936 A1
(43) Pub. Date: Mar. 20, 2025

(54) TECHNOLOGIES FOR FLEXIBLE SUBNETWORKS

(71) Applicant: Apple Inc., Cupertino, CA (US)

(72) Inventors: Christian Hofmann, Muenchen (DE); Ahmed Mohamed Ibrahim Hassan, Munich (DE); Dimitrios Alanis, Munich (DE); Milan Zivkovic, Munich (DE); Nikolai Bijovski Ribakov, Munich (DE); Panagiotis Botsinis, Munich (DE); Sameh M. Eldessoki, Munich (DE); Tarik Tabet, San Jose, CA (US)

(73) Assignee: Apple Inc., Cupertino, CA (US)

(21) Appl. No.: 18/806,601

(22) Filed: Aug. 15, 2024

Related U.S. Application Data
(60) Provisional application No. 63/583,173, filed on Sep. 15, 2023.

(51) Int. Cl. H04W 72/1268; H04W 8/18; H04W 72/21; H04W 72/543; H04W 74/0833; H04W 76/12

(52) U.S. Cl. CPC H04W 72/1268; H04W 8/18; H04W 72/21; H04W 72/543; H04W 74/0833; H04W 76/12

(57) ABSTRACT

The present application relates to devices and components including apparatus, systems, and methods for employing subnetworks to communicate with cellular networks.

### RELATED APPLICATIONS

This application claims priority to U.S. Provisional Patent Application No. 63/583,173, filed Sep. 15, 2023 and entitled “TECHNOLOGIES FOR FLEXIBLE SUBNETWORKS,” which is incorporated herein in its entirety.

### TECHNICAL FIELD

The present application relates to the field of wireless technologies and, in particular, to technologies to enable flexible subnetworks.

### BACKGROUND

Third Generation Partnership Project (3GPP) Technical Specifications (TSs) define the air interface to be used for radio access networks. These 3GPP TSs provide that base stations control resource management, admission control, mobility, and scheduling that take place within the radio access networks. While centralized control of the air interface provides some advantages, it also reduces deployment flexibility.

### BRIEF DESCRIPTION OF THE DRAWINGS

FIG. 1 illustrates a network environment in accordance with some embodiments.

FIG. 2 illustrates configurations in accordance with some embodiments.

FIG. 3 is a signaling diagram in accordance with some embodiments.

FIG. 4 illustrates configurations in accordance with some embodiments.

FIG. 5 is a signaling diagram in accordance with some embodiments.

FIG. 6 is a signaling diagram in accordance with some embodiments.

FIG. 7 is a signaling diagram in accordance with some embodiments.

FIG. 8 is a signaling diagram in accordance with some embodiments.

FIG. 9 illustrates the network environment with subnetwork tunneling protocol aspects in accordance with some embodiments.

FIG. 10 illustrates options for a subnetwork tunneling protocol layer in accordance with some embodiments.

FIG. 11 is an operation flow/algorithmic structure in accordance with some embodiments.

FIG. 12 is another operation flow/algorithmic structure in accordance with some embodiments.

FIG. 13 is another operation flow/algorithmic structure in accordance with some embodiments.

FIG. 14 is an example UE in accordance with some embodiments.

FIG. 15 is an example base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A) B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

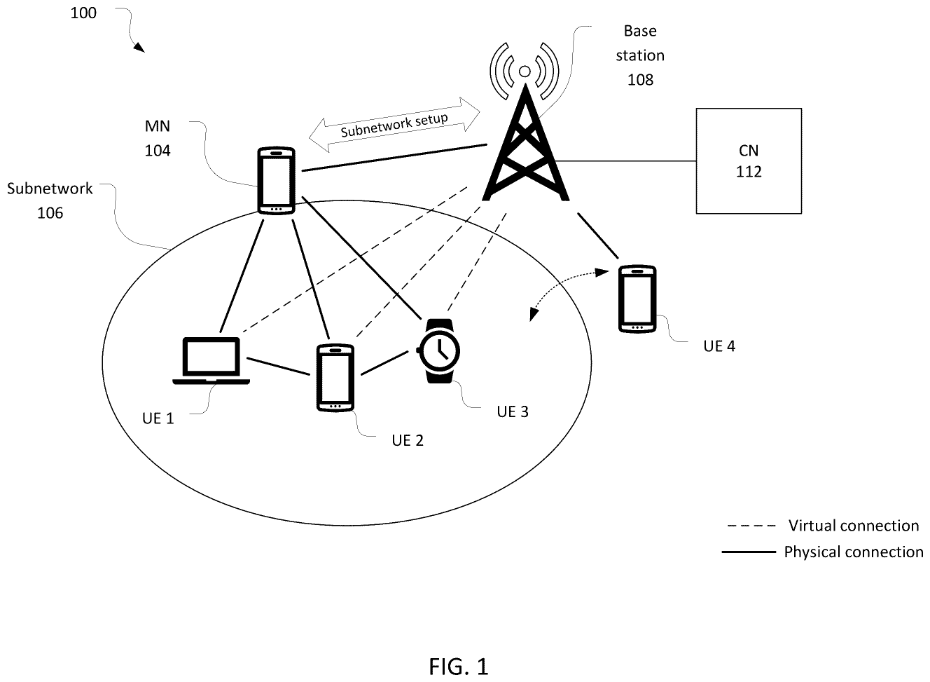

FIG. 1 illustrates a network environment 100 in accordance with some embodiments. The network environment 100 may include a base station 108 that provides one or more serving cells through which user equipments (UEs) may communicate with a cellular network. The base station 108 may be part of a radio access network (RAN) that is coupled with a core network (CN) 116.

The UEs and the base station 108 may communicate over air interfaces compatible with Fifth Generation (5G), Sixth Generation (6G), (or later) system standards as provided by 3GPP technical specifications.

The network environment 100 may include a management node (MN) 104 communicatively coupled with the base station 108 through a physical connection provided by the serving cell of the base station 108. The MN 104 may be a UE that provides a coordination role within a subnetwork 106.

The subnetwork 106 may include a number of UEs coupled with the MN 104. For example, the subnetwork 106 may include UE 1, UE 2, and UE 3. Each of these UEs may include a physical connection with the MN 104 and a virtual connection with the BS 108. The network environment 100 may also include a UE 4 that has a physical connection with the base station 108.

A physical connection, as used herein, may refer to a direct wireless connection between two devices at a physical layer of a network protocol stack. A virtual connection as used herein, may refer to a logical link between two devices. This logical link may include connections at layers above the physical layer of the network protocol stack.

The subnetwork 106 may be controlled by the MN 104 independent from a broader network (for example, a RAN controlled by the base station 108 or the CN 112). For example, the subnetwork 106 may utilize a technology independent from the RAN technology. The subnetwork 106 may use licensed or unlicensed spectrum, resources of which are granted, scheduled, or otherwise controlled by the MN 104 independent from direct control by the base station 108.

The MN 104 may form the subnetwork 106 for the UEs without (or with limited) configuration or awareness by the base station 108. The base station 108 may communicate with the MN 104 via a physical connection and may communicate with the UEs of the subnetwork 106 logically over the virtual connections. In some embodiments, the subnetwork topology and mobility within the subnetwork 106 may be transparent to the broader network (for example, the base station 108), which may decrease complexity of the broader network. The MN 104 may control various aspects of the subnetwork 106 including, for example, routing and resource management. The MN 104 may provide the quality of service (QOS) that provides a reliable end-to-end (E2E) link. This may be enabled by utilizing a fair scheduling mechanism across all UEs of the subnetwork 106 and with respect to other UEs of the network environment 100.

Control plane (CP) and user plane (UP) aspects of the subnetwork 106 may facilitate flexible and efficient communication of components of the subnetwork 106. For example, CP entities can be flexibly deployed on the MN 104 or local devices and can be transferred between subnetwork nodes. These deployments may be transparent to the broader network. With respect to the UP aspects, higher layers may terminate at a local device (e.g., protocol data unit (PDU) Session/Internet protocol (IP) addresses), and lower layers may terminate at the MN 104 and may be subnetwork-specific within the subnetwork 106 depending on the technology used (for example, licensed vs. unlicensed, device-to-device (D2D), etc.).

In some embodiments, a UE may be associated with the broader network. For example, a UE of the subnetwork 106 may remain registered with the broader network and have some aspects managed by the base station 108. For example the base station 108 may include a UE context and may control resources and mobility decisions with respect to the broader network (for example, such as handover between base stations of a cellular network).

In some embodiments, a UE may be able to seamlessly move between the subnetwork 106 and a broader network controlled by the base station 108. For example, the network environment 100 may include UE 4 that is capable of transitioning into, and out of, the subnetwork 106.

The MN 104 may cooperate with the base station 108 to set up the subnetwork 106. The MN 104 and the base station 108 may each include MN-interface configurations to facilitate set up and downlink/uplink signaling with respect to the subnetwork 106.

In some aspects, the subnetwork 106 and role of the MN 104 with respect to its coordinating role of the subnetwork 106, may be completely transparent to the broader network. Thus, the subnetwork 106 may be unknown by the base station 108 and the broader network may not be aware of the MN 104 as a man-in-the-middle. The MN 104 may, in essence, impersonate the subnetwork UEs. This may be done by the MN 104 performing communications with the base station 108 using the cell-radio network temporary identities (C-RNTIs) of the subnetwork UEs. Thus, the base station 108 may communicate with the individual subnetwork UEs, but the physical connection is actually with the MN 104.

This type of communication may present various challenges to be addressed. For example, the MN 104 may need capabilities to instantiate multiple UP/CP entities for all impersonated devices and may need to be capable of sending/receiving on behalf of every impersonated device in parallel. The MN 104 may need ensure that its device capabilities are not exceeded in performing these services.

In this scenario, the base station 108 may serve each subnetwork UE via a direct physical connection that terminates at the MN 104. The base station 108 may maintain independent contexts for each subnetwork UE and may maintain individual procedures per subnetwork UE (for example, layer 3 (L3), layer 1 (L1), channel state information (CSI)-measurements/reporting, location area (LA), tracking area (TA), etc.). This may require the same base-station and bandwidth resources as without subnetwork. Thus, this scenario may have limited aggregation benefits or optimizations due to the use of the subnetwork 106.

In other aspects of the disclosure, the base station 108 may be aware of the MN 104 and its role to manage local devices. This may include new CP and UP functionality. With respect to the UP functionality, the data plane for a certain subnetwork UE may be handled through the physical connection of the MN-base station interface in a transparent manner. Various embodiments describe aspects of the MN-base station interface to facilitate the deployment of flexible subnetworks.

In a first aspect of the present disclosure, virtual UE connections may be provided via a single physical connection over the MN-BS interface.

In the first aspect, the subnetwork UEs may be registered with the broader network. The broader network may manage at least some features of the subnetwork 106 at a higher level. In this embodiment, the base station 108 may maintain a UE context for each UE with which the base station 108 has a virtual or physical connection. The base station 108 may maintain the UE contexts while the UEs are within or outside the subnetwork 106.

The broader network may control resources and mobility decisions of the UEs in a global scope (for example, with respect to handovers between different base stations).

The base station 108 may be aware of which UEs are part of the subnetwork 106 that is controlled by the MN 104. The base station 108 may send information to the subnetwork UEs through the MN 104. For example, the broader network may send paging, user data, non-access stratum (NAS) control information, etc. through a virtual connection between the base station 108 and the subnetwork UEs. Signaling of the virtual connection may take place through a first physical connection over the MN-BS interface (for example, between the MN 104 and the base station 108) and a second physical connection over an MN-UE interface (for example, between the MN 104 and the subnetwork UEs). Thus, the base station 108 may only need one physical connection with the MN 104 to provide service to the MN 104 and all the subnetwork UEs. Physical layer operations (for example, channel estimation, CSI measurements, link adaptation, timing advance (TA), L3 measurement reporting, etc.) performed with respect to the one physical connection may be leveraged across the MN 104 and the subnetwork UEs. In contrast, communications with UEs outside the subnetwork 106, for example, UE 4, may involve individual physical layer operations for the individual physical connections.

The single physical connection with the MN 104 may define a maximum capacity/bandwidth for all the UEs managed by the MN 104. This may impact the scheduler of the base station 108 as it has to serve the subnetwork UEs as virtual UEs via the MN 104. This may involve the MN 104 needing to be served more frequently as compared to non-subnetwork UEs. Further, the bandwidth provided to the MN 104 may need to be shared among the MN-managed UEs.

Relying on one physical connection between the MN 104 and the base station 108 may allow a reduction of UE context and related procedural efforts of the base station 108 and subnetwork UEs since all link related information (L1 config, etc.) can be derived from an MN context.

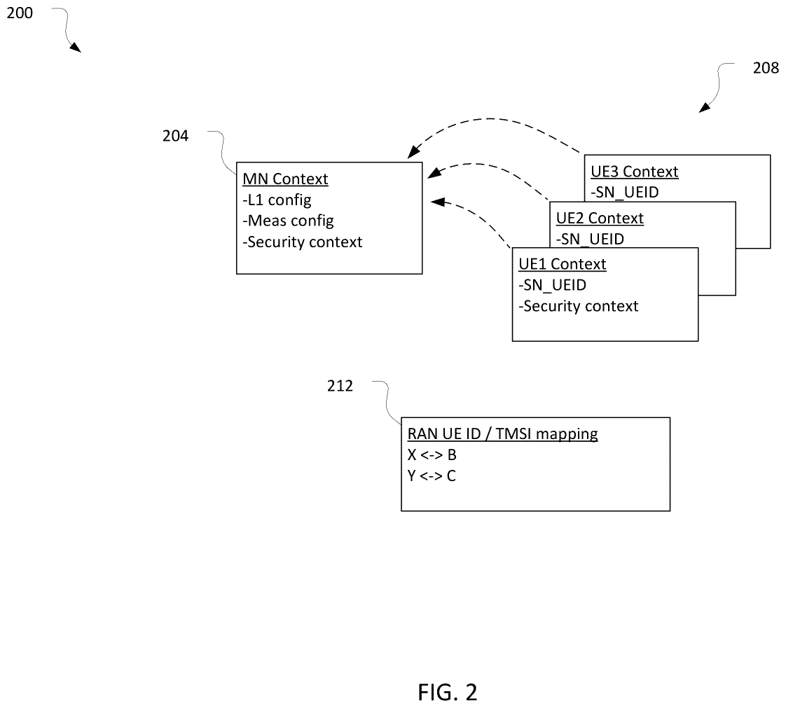

FIG. 2 illustrates configurations 200 stored at the base station 108 to facilitate communications within the network environment 100 in accordance with some embodiments. The configurations 200 may include an MN context 204, associated with the MN 104, and UE contexts 208, associated with the subnetwork UEs. The MN context 204 may include parameters used for physical layer operations associated with the physical connection between the MN 104 and the base station 108. These parameters may include, for example, an L1 configuration, a measurement configuration, and a security context to allow encryption/integrity verification of communications over the physical connection (for example, at a physical layer). The UE contexts 208 may include parameters used for communications over the virtual connections between the subnetwork UEs and the base station 108. These parameters may include, for example, an SN UE ID (SN_UEID) and a security context to allow encryption/integrity verification of communications over the virtual connections (for example, at layers above the physical layer).

In some embodiments, the UE contexts 208 may not include parameters that apply to physical layer operations. Thus, the UE contexts 208 may also be referred to as partial UE contexts 208.

The SN_UEID may be an identity of a subnetwork UE that is valid in the RAN while the subnetwork UE is connected to the base station 108 through the subnetwork 106. The SN_UEID may be used to identify/address the subnetwork UEs from the RAN/BS side. In instances in which a plurality of subnetworks are coupled with one base station, the SN_UEID may also serve to identify a particular subnetwork. The SN_UEID may be additionally/alternatively used for routing within the subnetwork 106 (for example, between the MN 104 and a particular subnetwork UE) or even for local inter-subnetwork communication (for example, a device-to-device (D2D) communication between subnetwork UEs (e.g., UE2<->UE3)).

The base station 108 may use the SN UE IDs to link the UE contexts 208 to the MN context 204. This linking may be updated when UEs enter or leave the subnetwork 106 as appropriate.

It may be noted that if a subnetwork UE is in a radio resource control (RRC) idle mode, the subnetwork UE may have little-to-no direct interaction with the RAN. In this case, the base station 108 may not need to maintain a valid SN UE ID as the MN 104 may handle the communications to the subnetwork UE without RAN involvement. For example, the MN 104 may listen for paging messages directed to the idle subnetwork UE.

In some embodiments, the base station 108 may assign a subnetwork UE with an SN_UEID when the subnetwork UE enters an RRC connected mode through the subnetwork 106.

To allow the base station 108 to properly direct data to/from the subnetwork UEs, the base station 108 may maintain an identity mapping 212. The identity mapping 212 may map an SN_UEID to an identity of the subnetwork UE used in the broader network, for example, a temporary mobile subscriber identity (TMSI). The SN UE ID may be mapped to the TMSI in a 1:1 manner. As shown, SN_UEID ‘X’ may be mapped to TMSI ‘B’ and SN_UEID ‘Y’ may be mapped to TMSI ‘C.’

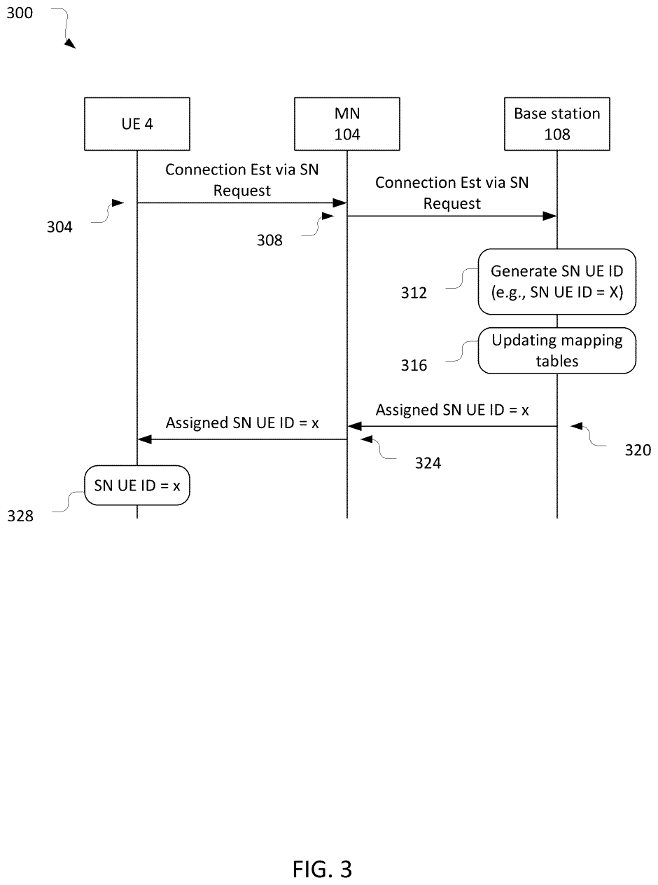

FIG. 3 is a signaling diagram 300 illustrating the UE 4 entering the subnetwork 106 in accordance with some embodiments.

The signaling diagram 300 may include, at 304, the UE 4 sending a connection establishment via SN request to the MN 104. The connection establishment via SN request may be a request to enter the subnetwork 106. Entering the subnetwork 106 may include having a physical connection with the MN 104 and a virtual connection with the base station 108. In some embodiments, the request may be sent when the UE 4 has a physical connection with the base station 108 and wants the physical connection to be transferred to the MN 104, while maintaining the virtual connection with the base station 108. In some embodiments, the request may be sent when the UE 4 does not have any connection with the base station 108 and wants the physical connection established with the MN 104 and the virtual connection established with the base station 108.

In some embodiments, the UE 4 may autonomously determine its intent to enter the subnetwork 106. For example, the UE 4 may determine to enter the subnetwork 106 based on its own initiative without direction or control by the base station 108.

The signaling diagram 300 may include, at 308, the MN 104 forwarding the connection establishment via SN request to the base station 108. By forwarding the request, the MN 104 informs the base station 108 about the UE 4 joining the subnetwork 106 and requesting connection via the MN 104.

At 312, the base station 108 may generate an SN UE ID that is to be assigned to the UE 4. As shown, the SN_UEID for the UE 4 may be ‘X.’

At 316, the base station 108 may update mapping tables. The mapping tables may be updated to associate the UE 4 with the MN 104. For example, the MN context may be associated with the UE 4 context. The updating of the mapping tables may additionally/alternatively associate the SN_UEID assigned to UE 4 with another ID of the UE 4, for example, a TMSI.

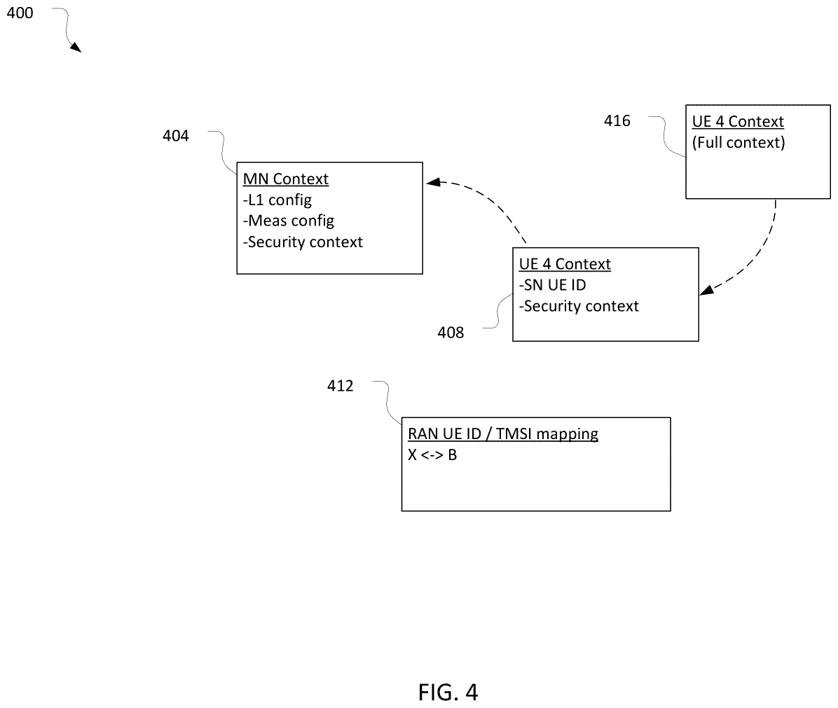

FIG. 4 illustrates configurations 400 stored at the base station 108 to describe an updating of mapping tables in accordance with some embodiments. The configurations 400 may include an MN context 404, associated with the MN 104, and UE context 408, associated with UE 4. Similar to the configurations 200, the MN context 404 may include parameters used for physical layer operations associated with the physical connection between the MN 104 and the base station 108, and the UE context 408 may include parameters used for communications over the virtual connections between the UE 4 and the base station 108.

In some embodiments, the configurations 400 may also include UE context 416 that may represent a full UE context. The UE context 416 may provide parameters that may be used for providing the UE 4 with connections at both the physical layer and higher logical layers. This may be used when the UE 4 has a physical connection with the base station 108. In some embodiments, when the UE 4 enters the subnetwork 106, the partial UE context 408 may be generated from the full UE context 416 and linked to the MN context 404 by way of the SN UE ID.

Upon generation of the SN_UEID, an identity mapping 412 may also be updated to link SN_UEID ‘X’ to TMSI ‘B,’ or another UE identity.

The signaling diagram 300 may further include, at 320, the base station 108 sending the assigned SN_UEID to the MN 104. The MN 104 may, in turn, forward the assigned SN_UEID to the UE 4 at 324. The UE 4 may store the SN_UEID at 328 for use in later communications.

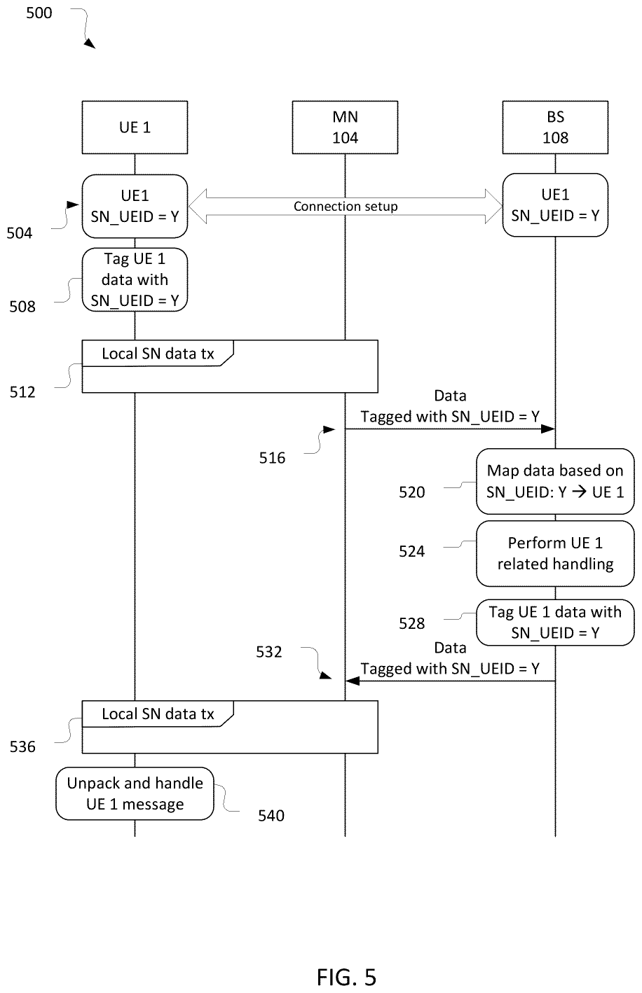

FIG. 5 is a signaling diagram 500 illustrating the UE 1 sending data through the subnetwork 106 in accordance with some embodiments.

The signaling diagram 500 may include, at 504, the UE 1 performing a connection setup with the base station 108 through the MN 104. The connection setup may assign SN_UEID ‘Y’ to UE 1 in a manner similar to that described above with respect to the signaling diagram 300.

The signaling diagram 500 may further include, at 508, the UE 1 tagging uplink data with SN_UEID=Y. The uplink data may be associated with an RRC message UE 1 is to transmit to the base station 108 via the MN 104.

The signaling diagram 500 may further include a local subnetwork data transmission at 512. This may be used to provide the uplink data to the MN 104. In some embodiments, the local subnetwork data transmission may be performed on resources scheduled by the MN 104 in licensed or unlicensed spectrum. In some embodiments, the UE 1 may perform a clear-channel assessment (CCA) to identify available resources shared by the subnetwork UEs. The UE 1 may then use the available resources to provide the data to the MN 104.

Upon receiving the uplink data, the MN 104 may transmit the data tagged with SN_UEID=Y to the base station 108 at 516. The MN 104 may transmit the data on uplink resources scheduled by the base station 108. The data may be transmitted using an identity of the MN 104, for example, a C-RNTI of the MN 104.

The signaling diagram 500 may further include, at 520, the base station 108 mapping the received data to the associated UE based on the SN_UEID tag. For example, the base station 108 may use the SN_UEID to map the data received with the C-RNTI of the MN 104 to the correct UE context of UE 1. The base station 108 may then perform, at 524, UE 1 related handling to process the tagged data based on the parameters of the UE 1 context. For example, if the tagged data is in an RRC message, the base station 108 may know from which UE it was received and act accordingly, for example, reply with an RRC reconfiguration message.

If the base station 108 receives (or generates) downlink data directed to the UE 1, the base station 108 may map a UE ID associated with the downlink data, as received by the base station 108, to the SN_UEID ‘Y’ based on the identity mapping 412. The base station 108 may then tag the UE 1 data with SN_UEID=Y at 528. In some examples, the downlink data may be associated with an RRC message the base station 108 is to transmit to UE 1 via the MN 104.

The base station 108 may access UE 1 context based on SN_UEID=Y, and identify the linked MN context. The base station 108 may then use the MN context to transmit the tagged data to the MN 104 at 532.

The MN 104 and UE 1 may perform a local subnetwork data transmission at 536 to provide the data to the UE 1 from the MN 104. The local subnetwork data transmission may be performed on subnetwork resources scheduled by the MN 104.

At 540, the UE 1 may unpack and handle the message received from the MN 104.

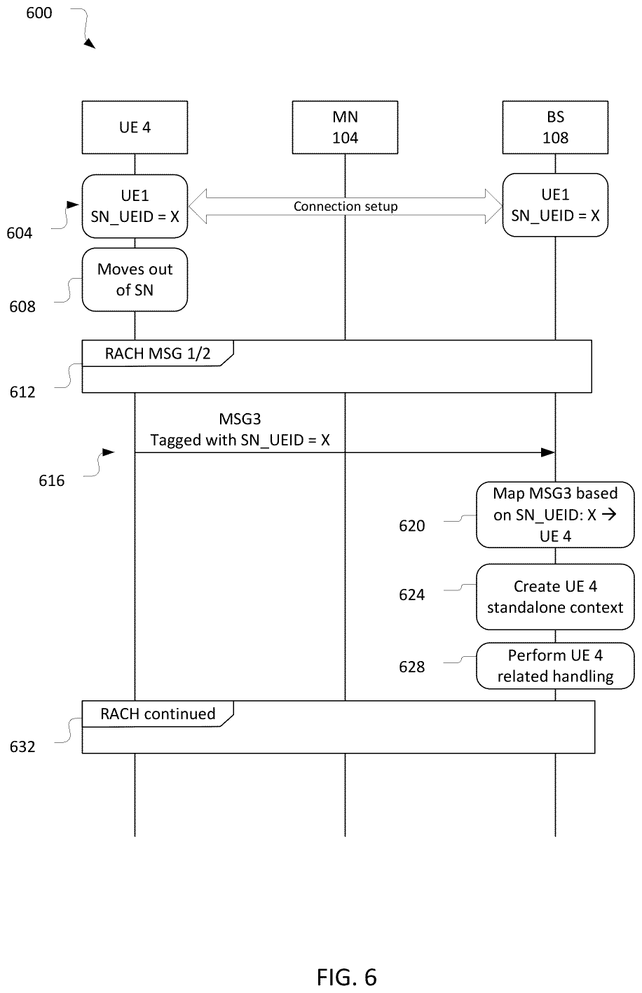

FIG. 6 is a signaling diagram 600 illustrating the UE 4 moving out of the subnetwork 106 in accordance with some embodiments. In the signaling diagram 600 includes the UE 4 leaves the subnetwork 106 and uses its SN_UEID during a RACH/connection setup to indicate its subnetwork identity.

The signaling diagram 600 may include, at 604, the UE 4 performing a connection setup with the base station 108 through the MN 104. The connection setup may assign SN_UEID ‘X’ to UE 4 in a manner similar to that described above with respect to the signaling diagram 300.

At 608, the UE 4 may move out of the subnetwork 106.

The signaling diagram 600 may include, at 612, the UE 4 and the base station 108 performing initial signaling of a random access channel (RACH) procedure. The initial signaling may include the UE 4 sending a random access (RA) preamble to the base station 108 in a message 1 (MSG1) transmission. The RA preamble may be selected by the UE 4 from a pool of preambles in a contention-based random access (CBRA) procedure or may be specifically assigned to the UE 4 in a contention-free random-access (CFRA) procedure. The base station 108 may respond with a random access response, which may be referred to as a message 2 (MSG2) transmission, that provides an uplink resource allocation.

The signaling diagram 600 may further include, at 616, the UE 4 transmitting a common control channel (CCCH) transmission, which may be referred to as a message 3 (MSG3) transmission. The MSG3 transmission may be tagged with SN_UEID=X.

At 620, the base station 108 may map the MSG3 transmission based on the SN_UEID tag. For example, the base station 108 may determine the MSG3 transmission is associated with UE 4 based on the SN_UEID ‘X’ tag.

The base station 108 may access the partial UE context associated with SN_UEID ‘X,’ (for example, UE context 408) and the MN context linked to the partial UE context (for example, MN context 404). Then, at 624, the base station 108 may create a standalone UE context for UE 4 (for example, UE 4 context 416) based on a combination of parameters from the MN context and the partial UE context.

The base station 108 may then perform, at 628, UE 1 related handling based on the parameters of the standalone UE context for UE 4.

The signaling procedure may further include, at 632, a continuation of the RACH procedure. This may include the base station 108 transmitting a contention resolution message (MSG4) that the UE 4 may decode to determine that the base station 108 successfully received the MSG3 transmission. The base station 108 may update an RRC state machine, followed by an RRC reconfiguration that establishes a physical connection between the base station 108 and the UE 4 and the SN_UEID assigned to the UE 4 may be released.

In a second aspect of the present disclosure, the base station 108 may provide the MN 104 with a UE-dedicated uplink grant towards the MN 104.

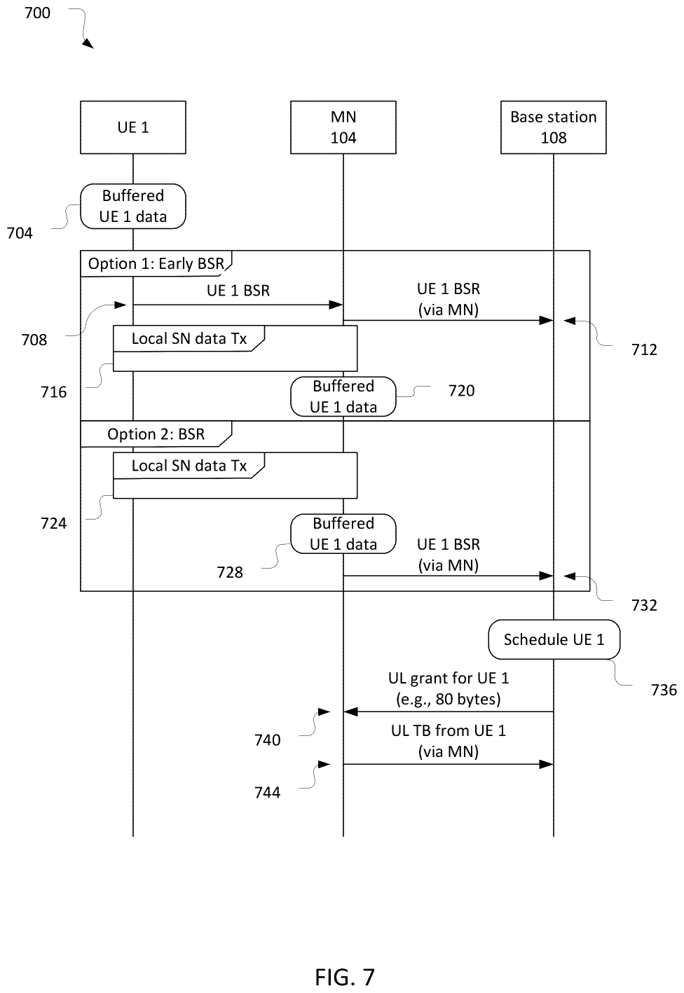

FIG. 7 is a signaling diagram 700 illustrating a UE-dedicated uplink grant toward the MN 104 in accordance with some embodiments.

The signaling diagram 700 may include, at 704, the UE 1 buffering data to be transmitted in an uplink.

The signaling diagram 700 includes two options for a buffer status report (BSR) that may be used for transmission of the data.

In a first option, which may be referred to as an early BSR option, the UE 1 may transmit a BSR to the MN 104 at 708. The BSR may indicate an amount of data in a buffer of the UE 1. The BSR may additionally/alternatively indicate other characteristics of the data in the buffer including, for example, a length of time the data has resided in the buffer, an amount of time the data has left to be timely transmitted, etc.

The MN 104 may forward the UE 1 BSR to the base station 108 at 712. After transmitting the BSR, the MN 104 may receive uplink data from the UE 1 via a local subnetwork data transmission at 716. The local subnetwork data transmission may take place as described elsewhere herein. Upon receiving the data, the MN 104 may buffer the UE 1 data at 720.

A second option, which may be referred to as a BSR option, may include the MN 104 receiving uplink data from the UE 1 via a local subnetwork data transmission at 724. The local subnetwork data transmission may take place as described elsewhere herein. Upon receiving the data, the MN 104 may buffer the UE 1 data at 728. At 732, the MN 104 may transmit a UE 1 BSR to the base station 108. The BSR may indicate an amount of UE 1 data in a buffer of the MN 104. The BSR may additionally/alternatively indicate other characteristics of the data in the buffer including, for example, a length of time the UE 1 data has resided in the buffer, an amount of time the UE 1 data has left to be timely transmitted, etc. The UE 1 BSR transmitted at 732 may identify buffer characteristics of the UE 1 data independent from data that may be buffered at the MN 104 for other subnetwork UEs. While this may occupy more memory resources of the MN 104 to allow per-UE UL buffer, this may also enable the UE-dedicated uplink grant as described as follows.

Upon receiving the UE 1 BSR (at 712 or 732), the base station 108 may schedule the UE 1. The scheduling of the UE 1 may include generating an uplink grant of resources that are to be used to transmit UE 1 data. The signaling diagram 700 may then include, at 740, the base station 108 transmitting the UL grant for UE 1 to the MN 104 at 740. The base station 108 may send the UE-dedicated UL grant via downlink control information (DCI) or a media access control (MAC) control element (CE). The MN 104 may transmit the UE 1 data (for example, an uplink transport block (TB) from UE 1) at 744.

In this manner, the MN 104 may act as a plurality of subnetwork UEs and utilize the UE-dedicated grants provided by the base station 108 for the data from the subnetwork UEs as appropriate. The grant distribution among the subnetwork UEs is under the control of the broader network, but is effectuated by the MN 104.

The signaling diagram 700 illustrates an embodiment in which the UE data is buffered at the MN 104, with the MN 104 compiling and forwarding per-UE BSRs to the base station 108. In some instances, this may add latency to the uplink transmissions. In other embodiments, UE data may be scheduled on-demand by the MN 104.

The on-demand scheduling may include per-UE BSRs being forwarded from the SN UEs to the MN 104 and then to the base station 108. The base station 108 then schedules per-UE UL grants and provides the grants to the MN 104. The MN may then pull respective data from the SN UEs and prepare an UL transmission to the base station 108. The on-demand scheduling may benefit from more flexible/dynamic/relaxed UL grant latencies.

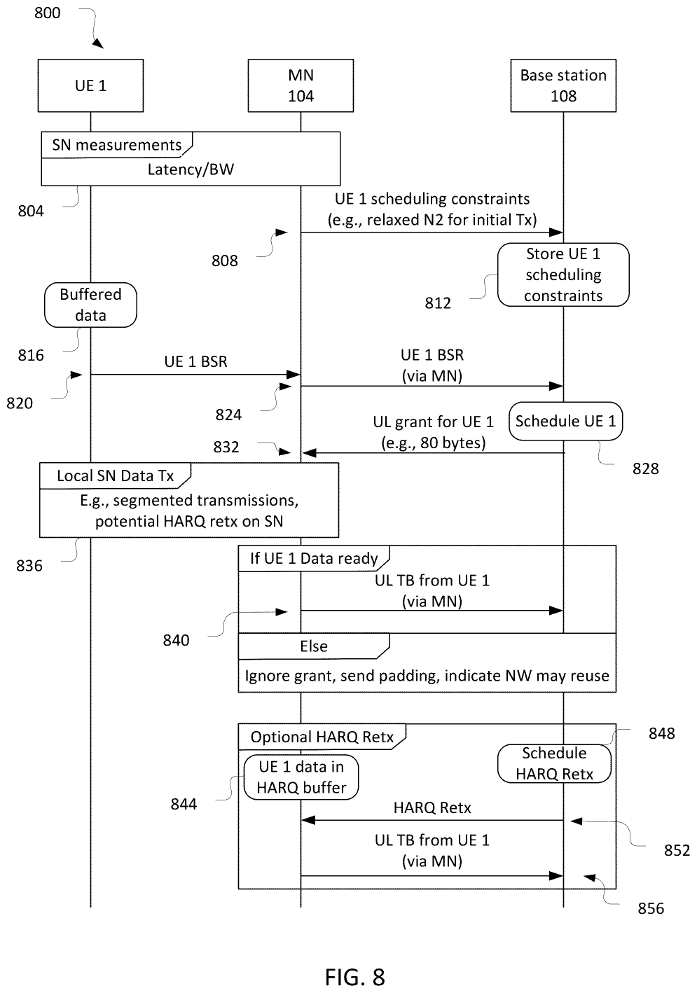

FIG. 8 is a signaling diagram 800 illustrating UE data may be scheduled on-demand by the MN 104 in accordance with some embodiments. The signaling diagram 800 may include, at 804, UE 1 and the MN 104 performing measurements of the subnetwork. The measurements may determine a channel quality/capacity of the physical connection between the UE 1 and the MN 104. In some embodiments, the SN measurements may determine latency and bandwidth characteristics of the physical connection.

The signaling diagram 800 may further include, at 808, the MN 104 determining UE 1 scheduling constraints and transmitting the scheduling constraints to the base station 108. The scheduling constraints may provide, for example, a relaxed N2 capability for an initial transmission. The N2 capability may provide a minimum time that a UE needs between receipt of an UL grant and the UL resources that it schedules.

The scheduling constraints may accommodate for the local link conditions (for example, path between MN 104 and UE 4) and the time the MN 104 needs to pull the data from within the subnetwork and deliver it to the base station 108. For example, if the local link is BW-limited or has bad quality, the MN 104 may incorporate multiple transmissions and/or potential retransmission (ReTx) attempts into the MN-associated N2 capability of the UE 4.

In some embodiments, the MN 104 may also consider its own N2 capability for deriving an MN-associated N2 capability per UE. In some instances, one N2 capability may be provided to the base station 108 that accounts for N2 capability of both the UE 1 and the MN 104. In other embodiments, separate N2 capabilities may be provided.

In some embodiments, the scheduling constraints may provide different sets of per-UE N2 capabilities. For example, one set may provide a standalone N2 capability of the UE 1, which may be used if the base station 108 has a physical connection with UE 1, and an MN-associated N2 capability, which may be used if the UE 1 is connected through the subnetwork 106.

The N2 capability reporting may be periodic or event-driven. This may help to accommodate changing conditions in the subnetwork 106.

In some embodiments, the scheduling constraints may additionally/alternatively include other per-UE limitations that may facilitate predictable subnetwork scheduling. For example, in some embodiments, the scheduling constrains may include a limit to a peak throughput of the UE 1. This may be done, for example, by setting maximum transport block size to encourage more frequent, but smaller TB transmissions.

In some embodiments, the scheduling constraints may additionally/alternatively include other per-UE limitations to address subnetwork characteristics or reduce MN complexity. For example, the scheduling constraints may include one or more time-division duplexing (TDD) patterns that may be used by particular subnetwork UEs or a limit of a number of subnetwork UEs that are to be scheduled in parallel.

In some embodiments, the scheduling constraints may be most useful for indirect connections between the base station 108 and a target UE to accommodate traversal over one or more intermediate nodes and extra latency when scheduling data that resides in a UE buffer.

The base station 108, may store the UE 1 scheduling constraints at 812.

At 816, the UE 1 may have buffered data to be transmitted in an uplink transmission. The UE 1 may send a UE 1 BSR to the MN 104 at 820. The BSR may be similar to that described elsewhere herein. The MN 104 may forward the UE 1 BSR to the base station 108 at 824.

At 828, the base station 108 may schedule the UE 1. In performing the scheduling, the BS 108 may consider whether the UE 1 is operating as standalone UE (in which case the standalone N2 capability would be used) or through the subnetwork 106 (in which case the MN-associated N2 capability may be used). The base station 108 may then transmit an uplink grant for the UE 1 at 832. The UL grant may schedule UL resources to be used to transmit the UE 1 data.

At 836, the MN 104 and the UE 1 may perform a local subnetwork data transmission. This may be performed similar to that described elsewhere herein. In some embodiments, the subnetwork data transmission may allow for a plurality of segmented transmissions and potentially, hybrid automatic repeat request (HARQ) retransmissions on the subnetwork 106. This may enable the MN 104 to accurately and fully collect the UE 1 data.

If the UE 1 data is ready for transmission in the UL resources scheduled by the UL grant, the signaling diagram may proceed to the MN 104 transmitting the UE 1 data (for example, uplink TB) to the base station 108 at 840. If the UE 1 data is not ready for transmission in the uplink resources scheduled by the uplink grant, the MN 104 may ignore the grant and send padding bits to the base station 108 to indicate that the broader network may reuse the resources.

In some embodiments, HARQ retransmissions may be enabled on the connection between the MN 104 and the base station 108. For example, the MN 104 may buffer the UE 1 data in a HARQ buffer of the MN 104 at 844. If the base station 108 does not successfully receive the transmission, it may schedule a HARQ retransmission at 848 and transmit an indication of the HARQ retransmission to the MN 104 at 852. The MN 104 may then transmit the UE 1 data (for example, UL TB) to the base station 108 from the HARQ buffer at 856.

While the signaling diagram 800 applies to uplink transmissions, similar concepts may also apply to downlink transmissions. For example, a scheduling latency between the DCI indicating a physical downlink shared channel (PDSCH) and an actual transmission (for example, a k0 parameter) may be more flexible/dynamic to allow the MN 104 to already indicate the incoming DL transmission to the respective target UE or reserve the downstream capacity.

In a third aspect of the present disclosure, the MN 104 and the base station 108 may employ a subnetwork tunneling protocol to facilitate subnetwork operations.

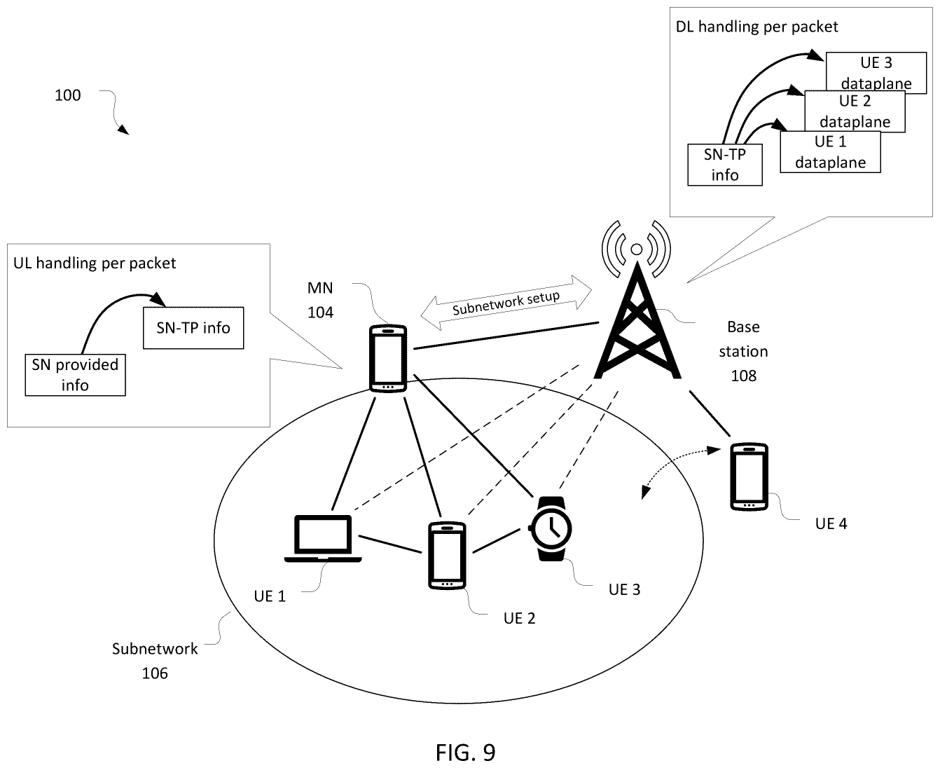

FIG. 9 illustrates the network environment 100 with subnetwork tunneling protocol (SN-TP) aspects in accordance with some embodiments.

The subnetwork UEs may have multiple QoS Flows (QFIs) that sum up to many data radio bearer (DRB)/logical channel (LC) entities in the MN 104 and base station 108 if each QFI is mapped 1:1 to DRBs. Thus, some embodiments aggregate different subnetwork UEs or UE QoS Flows into fewer (even one) DRB/RLC channel/LC entities between the MN 104 and the base station 108. This may help to limit the complexity of the MN 104 in terms of the number of DRB/LC entities it must provide for each device in the subnetwork 106.

SN-TP signaling may be used to carry UE/QoS Flow mapping information per packet between the MN 104 and the base station 108. The SN-TP signaling may be performed between SN-TP layers on the MN 104 and the base station 108. For example, in the downlink, the SN-TP layer at the base station 108 may add SN-TP information to packets of UE-specific dataplanes (e.g., UE 1 dataplane, UE 2 dataplane, and UE 3 dataplane). The SN-TP information, which may be added in an SN-TP header, may indicate which UE is targeted and which QoS flow to use. The MN 104 may access the SN-TP information from the SN-TP header and determine how to forward the data to the UEs through the subnetwork. In the uplink, the SN-TP layer at the MN 104 may map SN-provided information, which may include information about QoS flows used in the subnetwork 106, to SN-TP information. The SN-TP information may be added to an SN-TP header of uplink packets. The SN-TP information may provide the base station 108 with an indication of the DRBs/LCs to which the uplink data from the subnetwork UEs are to be mapped.

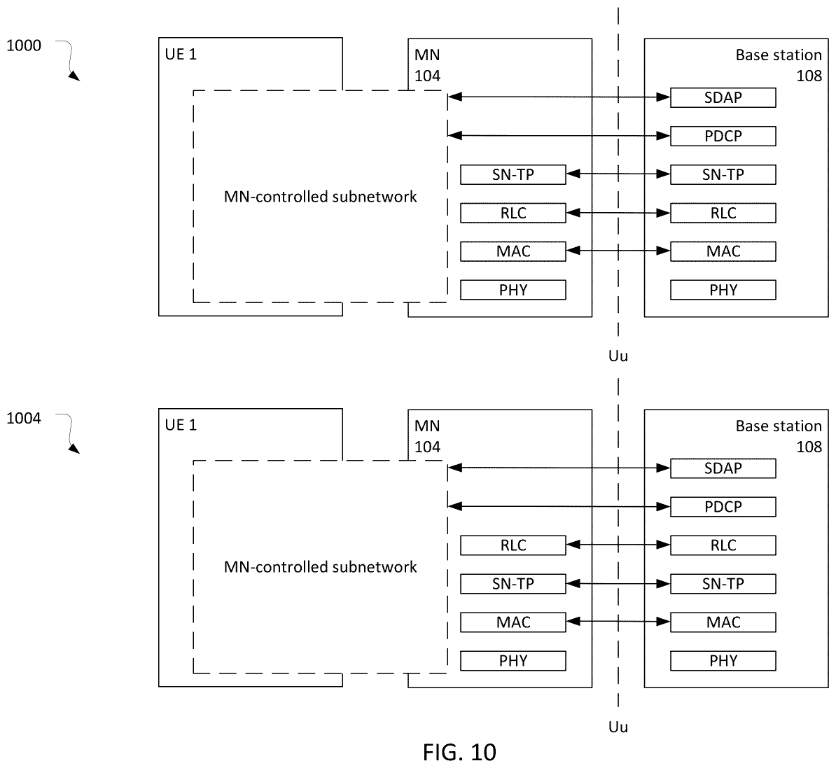

The SN-TP layers may be placed at various locations within a network protocol stack depending on where subnetwork UE traffic is to be aggregated within the subnetwork 106. FIG. 10 illustrates two options for implementing the SN-TP layer in accordance with some embodiments.

In a first option 1000, the SN-TP layers are placed above the RLC layers. This may enable multiplexing of SN traffic into a single RLC channel, a single RLC channel per UE within the subnetwork 106, or a single RLC channel per UE RLC channel. In some instances, placing the SN-TP layers above may RLC layers may enable aggregation of all DRBs of a UE into a single DRB of the UE.

Deploying the SN-TP layers on top of the RLC layers may enable various aggregation options, each of which may include benefits and challenges.

A first aggregation option may include aggregating all DRBs/QFIs of all UEs into one RLC channel. Resulting benefits may include that only one additional RLC channel needs to be supported between the MN 104 and the base station 108. A resulting challenge may include that such aggregation may create an inter-UE dependency (for example, an RLC Retx of a UE packet might cause head-of-line blocking for other UEs).

A second aggregation option may include aggregating all DRBs/QFIs of a single UE into one RLC channel. A resulting benefit may be that inter-UE dependency within RLC is reduced/eliminated as each UE may have its own channel and per-UE prioritization may be made possible to ensure end-to-end (E2E) QoS through the subnetwork 106. Resulting challenges may relate to inter-DRB dependency of traffic for the different DRBs of a single UE, or that a number of RLC channels scale with the subnetwork size. One possible mitigation may be to group UEs into a plurality of RLC Channels (for example, n:1).

A third aggregation option may include aggregating all QFIs across UE into one RLC channel. A resulting benefit may be that a number of RLC channels is bound to a number of QFIs used in the subnetwork. A resulting challenge may be that it creates an inter-UE dependency (RLC Retx of a UEs packet with QFI=x might cause head-of-line blocking for other UEs QFI=x packets).

In a second option 1004, the SN-TP layers are placed below the RLC layers. This may allow multiplexing of independent UEs LCs into a common per-UE TB. In this manner, different HARQ processes may be maintained for different subnetwork UEs.

While FIG. 10 shows two options of SN-TP layer placement, other placements may be used in other embodiments. For example, the SN-TP layer may be placed above PDCP or above SDAP.

In some embodiments, placement of the SN-TP layer may be based capabilities of the MN 104 or base station 108. The placement may be agreed upon during the formation of the subnetwork 106 or reconfigured during the lifetime of the subnetwork 106. For example, the placement of the SN-TP layers may be reconfigured when latency requirements of a certain subnetwork UE require a separation on the Uu interface.

Depending on where the SN-TP layer is deployed, it may carry different mapping information between MN 104 and the base station 108 in order to identify the proper UE-related protocol entities. For example, if the SN-TP layers are above the RLC as shown in option 1, the SN-TP layer may provide SN-TP information such as a UE ID and a resource bearer (for example, DRB) ID. And, if the SN-TP layers are below the RLC as shown in option 2, the SN-TP layer may provide SN-TP information such as a UE ID and an LC ID.

Embodiments of the present disclosure are associated with a variety of benefits as compared to integrated access and backhaul (IAB)/sidelink (SL) relay. Some of these benefits may be due to the subnetworks being capable of using any technology and licensed/unlicensed spectrum. This may provide more flexibility as the MN 104 and the base station 108 may negotiate certain characteristics (for example, scheduling constraints, maximum bandwidth) and then the MN 104 may deploy the subnetwork 106 without further constraints by the broader network.

Compared to IAB/SL relay, the intra-subnetwork link scheduling, node configuration, and mobility may not be visible to the broader network. This may increase subnetwork transparency and reduce complexity in the broader network. While the base station 108 may remain an anchor for the subnetwork UEs, the base station 108 may schedule the subnetwork UEs behind the MN 104 in the same way as UEs directly connected to the base station 108. The subnetwork 106 is not controlled by the broader network, and its internals are transparent. Topology changes in the subnetwork 106 do not rely on the broader network and, in some instances, the broader network may only be aware of subnetwork operation in cases of inter-MN mobility or UEs entering/leaving the subnetwork 106.

Complexity of the MN 104 may be lower than that of IAB nodes. The MN 104 may have a relatively simple scheduler that is instructed by the base station 108. The main logic of fair scheduling across different users remains in the base station 108 and is unchanged.

In some embodiments, MN-controlled subnetworks move the subnetwork formation/control towards the UEs. In these embodiments, the use case may change from a network operator-owned use case, towards a UE/subscriber-owned use case.

As compared to IAB/SL relay, the QoS of an MN-controlled subnetwork may be managed by the base station from outside the subnetwork, without full control over the subnetwork. In IAB, the base station handles aggregated traffic from its child IAB node(s) and configures and controls all IAB nodes along the path. In SL relay the base station schedules the PC5 links along the path (Mode1) or the UEs autonomously communicate in D2D fashion (Mode2), there is no MN-controlled subnetwork.

In MN-controlled subnetworks, the base station of the RAN may maintain E2E QOS per UE and per UE's LC. This may be done by scheduling UEs individually while the subnetwork characteristics (for example, bandwidth limitations and latency/scheduling constraints) are abstracted to the broader network.

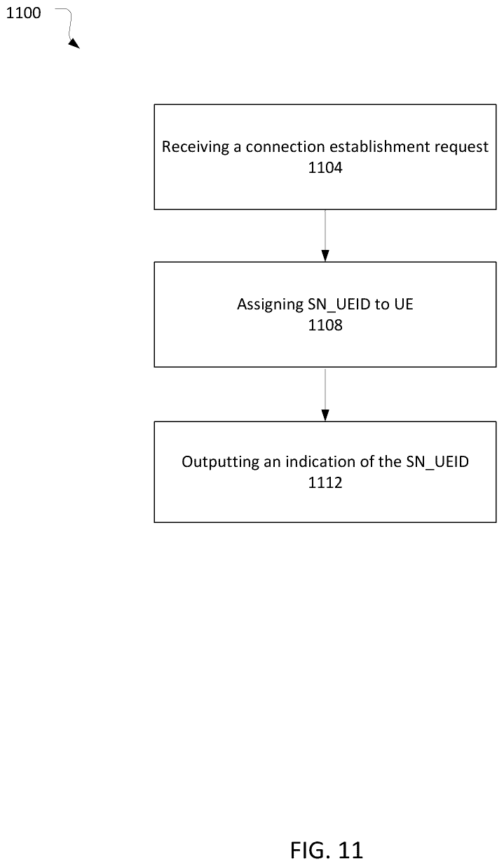

FIG. 11 is an operation flow/algorithmic structure 1100 in accordance with some embodiments. For example, the operation flow/algorithmic structure 1100 may be executed by a base station, such as base station 108, base station 1500, or components thereof, for example, processors 1504.

The operation flow/algorithmic structure 1100 may include, at 1104, receiving a connection establishment request. The connection establishment request may be received from an MN of a subnetwork. The connection establishment request may request that a UE be admitted to a RAN controlled by the base station via the subnetwork.

The operation flow/algorithmic structure 1100 may further include, at 1108, assigning an SN_UEID to a UE. In some embodiments, the SN_UEID assigned to the UE may be populated in a partial UE context, which may be derived from a full UE context. In addition to the SN_UEID, the partial UE context may include a security context associated with the UE. The security context may be used to secure communications transmitted over a virtual connection between the base station and the UE. The partial UE context may be linked to a context of the MN from which the connection establishment request was received. The MN context may include parameters applicable to communications over direct connection with the MN. These parameters may include, for example, an L1 configuration, a measurement configuration, and a security context associated with the MN.

In some embodiments, the SN_UEID assigned to the UE may also be linked with an ID of the UE used in communications via a broader network (for example, a TMSI of the UE).

The operation flow/algorithmic structure 1100 may further include, at 1112, outputting an indication of the SN_UEID. The indication may be output for transmission to the MN from which the communication establishment request was received.

Subsequent to transmitting the indication of the SN_UEID, the base station may receive a transmission from the MN. The transmission may be received based on a C-RNTI of the MN and may include data and an indication of the SN_UEID. The base station may use the SN_UEID to identify the partial UE context and other UE ID (for example, the TMSI of the UE) and may forward the data based on the context and the other UE ID.

The base station may receive data from an external network that is directed to the UE. The data may be associated with another UE ID (for example, the TMSI of the UE). The base station may map the other UE ID to the SN_UEID and access the partial UE context and a linked MN context based on the mapping. The base station may then transmit the data to the UE via the MN based on the partial UE context and the MN context. The transmission may include an indication of the SN_UEID to enable the MN to route the data to the UE through the subnetwork.

In some embodiments, the base station may receive a RACH transmission (for example, a MSG3 transmission) with an indication of the SN_UEID. The base station may identify the partial UE context and the MN context based on the SN_UEID and generate a standalone UE context by combining parameters from the two contexts. The base station may then transmit a response to the RACH transmission (for example, a MSG4 transmission) to establish a direct connection with the UE.

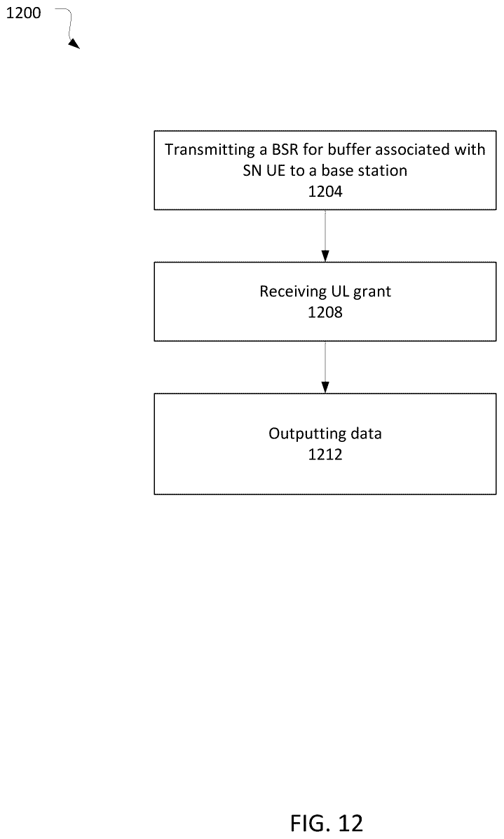

FIG. 12 is an operation flow/algorithmic structure 1200 in accordance with some embodiments. For example, the operation flow/algorithmic structure 1200 may be executed by an MN, such as MN 104, UE 1400, or components thereof, for example, processors 1404.

The operation flow/algorithmic structure 1200 may include, at 1204, transmitting a BSR that indicates a status of an uplink transmit buffer associated with a subnetwork UE. In some embodiments the uplink transmit buffer may be on the MN. The MN may receive data from the subnetwork UE and store the data in an uplink transmit buffer dedicated to the subnetwork UE. The MN may then generate the BSR based on its uplink transmit buffer. In other embodiments, the uplink transmit buffer may be on the subnetwork UE. In this case, the MN may receive the BSR from the subnetwork UE and forward the BSR to the base station. The MN may then receive the data from the subnetwork UE.

The operation flow/algorithmic structure 1200 may further include, at 1208, receiving an uplink grant. The uplink grant may schedule resources to be used for uplink transmission of data from the subnetwork UE. In some embodiments, the scheduled resources may be dedicated to data from the subnetwork UE.

The operation flow/algorithmic structure 1200 may further include, at 1212, outputting data for transmission using resources indicated by the uplink grant. In some embodiments, the MN may determine a scheduling constraint of the subnetwork UE and provide an indication of the scheduling constraint to the base station. This may be based on a condition of a link between the MN and the subnetwork UE. The scheduling constraint may provide a time value this is needed between receipt of an uplink grant and transmission of the uplink data. In some embodiments, the scheduling constraint may be an MN-associated scheduling constraint that is applicable when the UE is connected to the subnetwork and the MN may also provide a standalone scheduling constraint that is applicable when the UE has a direct connection with the base station. The transmission of the indication of the scheduling constraint may be based on a detected event. The event may be a periodic event (for example, expiration of a timer) or a condition (for example, a change in characteristics of the subnetwork).

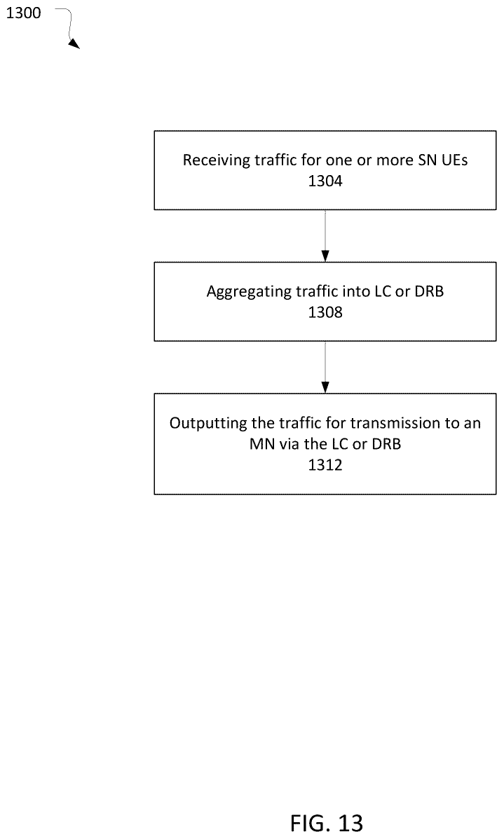

FIG. 13 is an operation flow/algorithmic structure 1300 in accordance with some embodiments. For example, the operation flow/algorithmic structure 1300 may be executed by a base station, such as base station 108, base station 1500, or components thereof, for example, processors 1504.

The operation flow/algorithmic structure 1300 may include, at 1304, receiving traffic for one or more subnetwork UEs. In some embodiments, the traffic may be received via a plurality of QoS flows.

The operation flow/algorithmic structure 1300 may further include, at 1308, aggregating the traffic into an LC or radio bearer (RB) (for example, a DRB or signaling radio bearer (SRB)). In some embodiments, aggregation of the traffic may be performed by generating packets with SN-TP headers. Each SN-TP header may include mapping information associated with the LC or RB. In some instances, the mapping information may map QoS flows to an LC/RB. The mapping information may include an identity associated with the UE (for example, a UE ID) and an indication of the LC or RB (for example, an LC/RB ID). The UE ID may be an SN_UEID or an identity used at a broader network level.

The operation flow/algorithmic structure 1300 may further include, at 1312, outputting the traffic for transmission to an MN via the LC or RB.

In some embodiments, the operation flow/algorithmic structure 1300 may be implemented by an SN-TP layer of a base station. The SN-TP layer may be above or below an RLC layer of the base station. The location of the SN-TP layer may be dynamically configured based on, for example, desired objectives of a particular situation.

While FIGS. 11-13 may imply an order of the operation, it should be understood that the operations may be performed in a different order or one or more of the operations may be performed concurrently in other embodiments. Additionally, it should be understood that one or more additional operations may be included in the operation flows/algorithmic structure or one or more of the operations may be omitted in other embodiments.

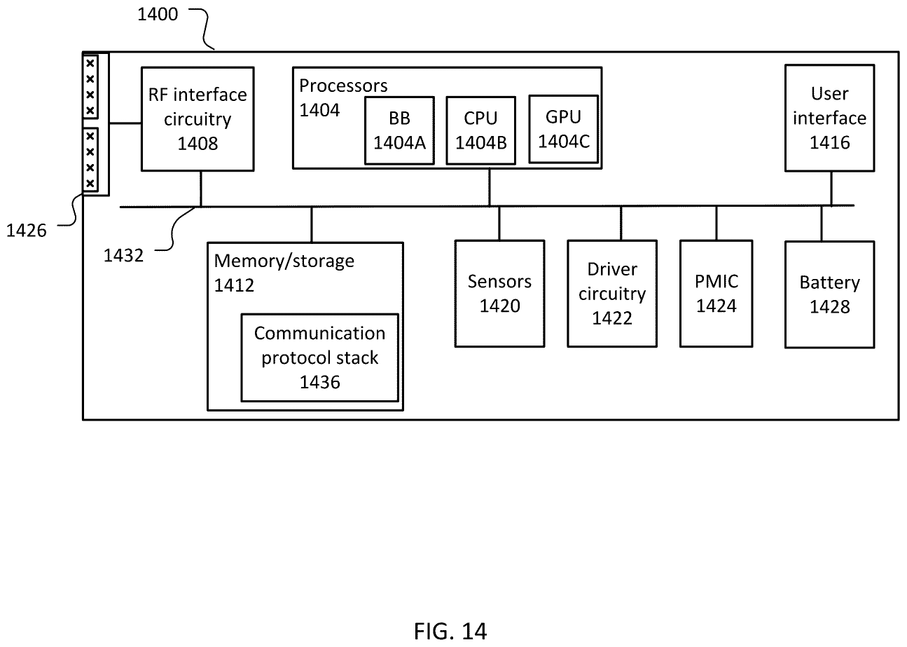

FIG. 14 illustrates an example UE 1400 in accordance with some embodiments. The UE 1400 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations such as those described with respect to FIGS. 11-13 or elsewhere herein. In some embodiments, the instructions may implement an SN-TP layer to perform some or all of these operations.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, SN-TP layer, PDCP layer, SDAP layer, and PDU layer; and perform control plane functions at a PHY layer, MAC layer, RLC layer, SN-TP layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1426.

In various embodiments, the RF interface circuitry 1408 may be configured to transmit/receive signals in a manner compatible with NR access technologies.

The antenna structure 1426 may include antenna elements to convert electrical signals into radio waves to travel through the air and to convert received radio waves into electrical signals. The antenna elements may be arranged into one or more antenna panels. The antenna structure 1426 may have antenna panels that are omnidirectional, directional, or a combination thereof to enable beamforming and multiple input, multiple output communications. The antenna structure 1426 may include microstrip antennas, printed antennas fabricated on the surface of one or more printed circuit boards, patch antennas, phased array antennas, etc. The antenna structure 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc. The UE 1400 goes into a very low power state, and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

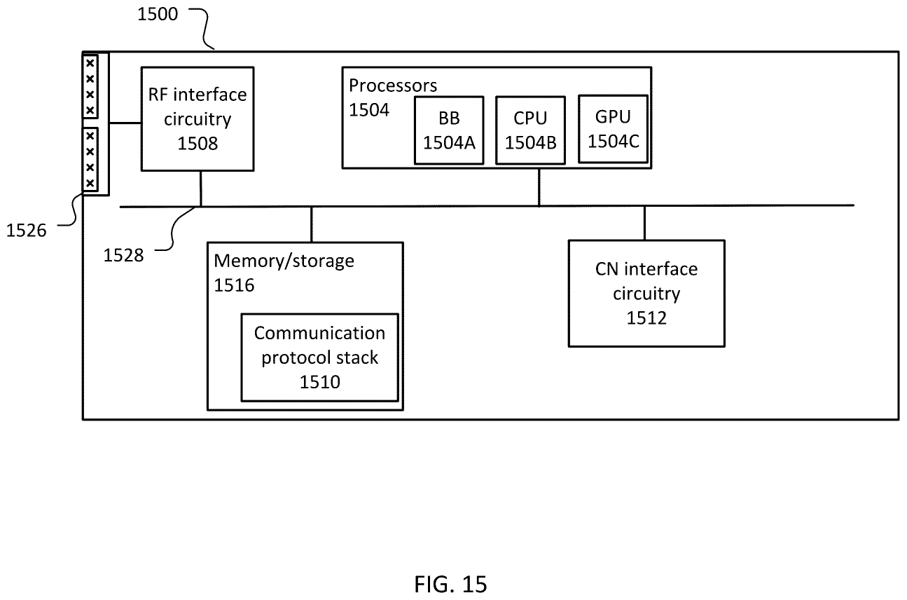

FIG. 15 illustrates an example base station 1500 in accordance with some embodiments. The base station 1500 may include processors 1504, RF interface circuitry 1508, core network (CN) interface circuitry 1512, memory/storage 1516, and antenna structure 1526.

The components of the base station 1500 may be coupled with various other components over one or more interconnects 1528.

The processors 1504, RF interface circuitry 1508, memory/storage 1516 (including communication protocol stack 1510), antenna structure 1526, and interconnects 1528 may be similar to like-named elements shown and described with respect to FIG. 14.

The processors 1504 may include any type of circuitry or processor circuitry that executes or otherwise operates computer-executable instructions, such as program code, software modules, or functional processes from memory/storage 1516 to cause the base station 1500 to perform operations such as those described with respect to FIGS. 11-13 or elsewhere herein.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the base station 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method to be implemented by a base station of a radio access network (RAN), the method comprising: receiving, from a management node (MN) of a subnetwork, a connection establishment request to request that a user equipment (UE) be admitted to the RAN via the subnetwork; assigning a subnetwork (SN) UE identity (ID) to the UE; outputting, for outputting, for transmission to the MN, an indication of the SN UE ID.

Example 2 includes a method of example 1 or some other example herein, further comprising: linking a context of the UE with a context of the MN.

Example 3 includes the method of example 2 or some other example herein, wherein the context of the UE includes the SN_UEID and a security context associated with the UE and the context of the MN includes a layer 1 configuration, a measurement configuration, and a security context associated with the MN.

Example 4 includes a method of example 1 or some other example herein, further comprising: linking the SN_UEID with a temporary mobile subscriber identity (TMSI) associated with the UE.

Example 5 includes the method of example 1 or some other example herein, further comprising: receiving, based on a cell-radio network temporary identifier (C-RNTI) associated with the MN, a transmission that includes data and an indication of the SN_UEID; identifying the context of the UE based on the SN_UEID; and forwarding the data based on the context of the UE.

Example 6 includes the method of example 1 or some other example herein, further comprising: receiving data directed to the UE, the data associated with an identity of the UE; mapping the identity to the SN_UEID; accessing a context of the UE based on the SN_UEID; accessing a context of the MN that is associated with the context of the UE; and outputting the data for transmission to the UE via the MN based on the context of the MN.

Example 7 includes the method of example 6 or some other example herein, further comprising: outputting the data with an indication of the SN_UEID.

Example 8 includes the method of example 1 or some other example herein, further comprising: receiving, from the UE, a random access channel (RACH) transmission with an indication of the SN_UEID; identifying a context of the UE and a context of the MN based on the SN_UEID; generating a standalone UE context based on the context of the UE and the context of the MN; and outputting a response to the RACH transmission to establish a direct connection with the UE.

Example 9 includes a method to be implemented by a managing node (MN) of a subnetwork, the method comprising: transmitting, to a base station, a buffer status report (BSR) that indicates a status of an uplink transmit buffer that is associated with a user equipment (UE) of the subnetwork; receiving, from a base station, an uplink grant that schedules resources to be used for uplink transmission of data from the UE; and outputting the data from the UE using the resources.

Example 10 includes a method of example 9 or some other example herein, wherein the uplink transmit buffer is on the MN and the method further comprises: receiving the data from the UE; storing the data in the uplink transmit buffer; and generating the BSR.

Example 11 includes the method of example 9 or some other example herein, wherein the uplink transmit buffer is on the UE and the method further comprises: receiving the BSR from the UE.

Example 12 includes the method of example 11 or some other example herein, further comprising: receiving, after outputting the BSR, the data from the UE.

Example 13 includes the method of any one of examples 9-12 or some other example herein, further comprising: determining, based on a condition of a link between the MN and the UE, a scheduling constraint of the UE; and outputting the scheduling constraint for transmission to the base station.

Example 14 includes the method of example 13 or some other example herein, wherein the scheduling constraint is an MN-associated scheduling constraint and the method further comprises: outputting a standalone scheduling constraint of the UE for a direct connection between the UE and the base station.

Example 15 includes the method of example 13 or some other example herein, further comprising: detecting an event; and outputting the scheduling constraint for transmission to the base station based on the event.

Example 16 includes a method of example 15 or some other example herein, further comprising: detecting the event based on the condition.

Example 17 includes a method of example 9 or some other example herein, further comprising: outputting, for transmission to the base station, an indication of a transport block size limitation associated with traffic directed to the UE via the subnetwork.

Example 18 includes a method of example 9 or some other example herein, further comprising: outputting, for transmission to the base station, an indication of a time division duplex (TDD) pattern associated with the UE or a limitation on a number of UEs of the subnetwork that are to be scheduled in parallel.

Example 19 includes a method to be implemented by a base station, the method comprising: receiving traffic for one or more user equipments (UEs) of a subnetwork; aggregating the traffic into a logical channel (LC) or radio bearer (RB); and outputting the traffic for transmission to a management node (MN) of the subnetwork via the LC or RB.

Example 20 includes the method of example 19 or some other example herein, wherein: aggregating the traffic into an LC or RB includes generating a packet with a subnetwork-tunneling protocol (SN-TP) header, having mapping information associated with the LC or RB, and a payload, having data for a UE of the one or more UEs; and outputting the traffic includes outputting the packet to the MN.

Example 21 includes a method of example 19 or some other example herein, wherein the mapping information includes an identity associated with the UE and an indication of the LC or RB.

Example 22 includes a method of example 19 or some other example herein, further comprising: receiving the traffic in a plurality of quality of service flows.

Example 23 includes method of example 19 or some other example herein, further comprising: aggregating the traffic into the LC or RB at a subnetwork-tunneling protocol (SN-TP) layer of the base station, wherein the SN-TP layer is above or below a radio link control (RLC) layer of the base station.

Example 24 includes a method of example 23 or some other example herein, further comprising: outputting, for transmission to the MN, information to configure the SN-TP layer to be above or below the RLC layer.

Another example may include an apparatus comprising means to perform one or more elements of a method described in or related to any of examples 1-24, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Another example may include an apparatus comprising logic, modules, or circuitry to perform one or more elements of a method described in or related to any of examples 1-24, or any other method or process described herein.

Another example may include a method, technique, or process as described in or related to any of examples 1-24, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-24, or portions thereof.

Another example may include a signal as described in or related to any of examples 1-24, or portions or parts thereof.

Another example may include a datagram, information element, packet, frame, segment, PDU, or message as described in or related to any of examples 1-24, or portions or parts thereof, or otherwise described in the present disclosure.

Another example may include a signal encoded with data as described in or related to any of examples 1-24, or portions or parts thereof, or otherwise described in the present disclosure.

Another example may include a signal encoded with a datagram, IE, packet, frame, segment, PDU, or message as described in or related to any of examples 1-24, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Another example may include a computer program comprising instructions, wherein execution of the program by a processing element is to cause the processing element to carry out the method, techniques, or process as described in or related to any of examples 1-24, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving, from a management node (MN) of a subnetwork, a connection establishment request to request that a user equipment (UE) be admitted to a radio access network (RAN) via the subnetwork;
assigning a subnetwork (SN) UE identity (ID) to the UE; and
outputting, for transmission to the MN, an indication of the SN UE ID.

2. The method of claim 1, further comprising:
linking a context of the UE with a context of the MN.

3. The method of claim 2, wherein the context of the UE includes the SN UE ID and a security context associated with the UE and the context of the MN includes a layer 1 configuration, a measurement configuration, and a security context associated with the MN.

4. The method of claim 2, further comprising:
receiving, based on a cell-radio network temporary identifier (C-RNTI) associated with the MN, a transmission that includes data and an indication of the SN UE ID;
identifying the context of the UE based on the SN UE ID; and
forwarding the data based on the context of the UE.

5. The method of claim 1, further comprising:
linking the SN UE ID with a temporary mobile subscriber identity (TMSI) associated with the UE.

6. The method of claim 1, further comprising:
receiving data directed to the UE, the data associated with an identity of the UE;
mapping the identity to the SN UE ID;
accessing a context of the UE based on the SN UE ID;
accessing a context of the MN that is associated with the context of the UE; and
outputting the data with an indication of the SN UE ID for transmission to the UE via the MN based on the context of the MN.

7. The method of claim 1, further comprising:
receiving, from the UE, a random access channel (RACH) transmission with an indication of the SN UE ID;
identifying a context of the UE and a context of the MN based on the SN UE ID;
generating a standalone UE context based on the context of the UE and the context of the MN; and
outputting a response to the RACH transmission to establish a direct connection with the UE.

8. One or more non-transitory, computer-readable media having instructions that, when executed, cause processing circuitry to:
output, for transmission to a base station, a buffer status report (BSR) that indicates a status of an uplink transmit buffer that is associated with a user equipment (UE) of a subnetwork;
receive, from the base station, an uplink grant that schedules resources to be used for uplink transmission of data from the UE; and
output the data from the UE using the resources.

9. The one or more non-transitory, computer-readable media of claim 8, wherein the uplink transmit buffer is on a management node (MN) and the instructions, when executed, further cause the processing circuitry to:
receive the data from the UE;
store the data in the uplink transmit buffer; and
generate the BSR.

10. The one or more non-transitory, computer-readable media of claim 8, wherein the uplink transmit buffer is on the UE and the instructions, when executed, further cause the processing circuitry to:
receive the BSR from the UE; and
receive, after transmission of the BSR, the data from the UE.

11. The one or more non-transitory, computer-readable media of claim 8, wherein the instructions, when executed, further cause the processing circuitry to:
determine, based on a condition of a link between a management node (MN) and the UE, a scheduling constraint of the UE; and
output the scheduling constraint for transmission to the base station.

12. The one or more non-transitory, computer-readable media of claim 11, wherein the scheduling constraint is an MN-associated scheduling constraint and the instructions, when executed, further cause the processing circuitry to:
output a standalone scheduling constraint of the UE for a direct connection between the UE and the base station.

13. The one or more non-transitory, computer-readable media of claim 11, wherein the instructions, when executed, further cause the processing circuitry to:
detect an event based on the condition; and
output the scheduling constraint for transmission to the base station based on the event.

14. The one or more non-transitory, computer-readable media of claim 8, wherein the instructions, when executed, further cause the processing circuitry to:
output, for transmission to the base station, an indication of a transport block size limitation associated with traffic directed to the UE via the subnetwork.

15. The one or more non-transitory, computer-readable media of claim 8, wherein the instructions, when executed, further cause the processing circuitry to:
output, for transmission to the base station, an indication of a time division duplex (TDD) pattern associated with the UE or a limitation on a number of UEs of the subnetwork that are to be scheduled in parallel.

16. An apparatus comprising:
interface circuitry;
processing circuitry coupled with the interface circuitry, the processing circuitry to:
receive traffic for one or more user equipments (UEs) of a subnetwork;
aggregate the traffic into a logical channel (LC) or radio bearer (RB); and
output the traffic, via the interface circuitry, for transmission to a management node (MN) of the subnetwork via the LC or RB.

17. The apparatus of claim 16, wherein:
to aggregate the traffic into an LC or RB the processing circuitry is to generate a packet with a subnetwork-tunneling protocol (SN-TP) header having mapping information associated with the LC or RB and a payload having data for a UE of the one or more UEs; and
to output the traffic the processing circuitry is to output the packet for transmission to the MN.

18. The apparatus of claim 17, wherein the mapping information includes an identity associated with the UE and an indication of the LC or RB.

19. The apparatus of claim 16, wherein the processing circuitry is further to:
receive the traffic in a plurality of quality of service flows.

20. The apparatus of claim 16, wherein the processing circuitry is further to:
aggregate the traffic into the LC or RB at a subnetwork-tunneling protocol (SN-TP) layer of a base station; and
output, for transmission to the MN, information to configure the SN-TP layer to be above or below a radio link control (RLC) layer of the base station.
